(19) United States
(12) Patent Application Publication
(10) Pub. No.: US 2007/0215415 A1
(43) Pub. Date: Sep. 20, 2007

(54) Braking device for a bicycle

(76) Inventors: Montanari Sandro, Taichung City (TW); Righi Ermanno, (US)

Correspondence Address: MONTANARI SANDRO, 235 Chung-Ho, Box 8-24, Taipei, TW

(21) Appl. No.: 11/374,568

(22) Filed: Mar. 14, 2006

(51) Int. Cl. B62L 1/02

(52) U.S. Cl. 188/24.14; 188/24.12; 188/72.2

(57) ABSTRACT

A braking device for a bicycle activated by transverse pull mainly comprises a lever set with a pair of left and right braking components, each having an active member and a passive member that are opposite wedged slab bodies slidably engaged. The active members are further attached with braking members. The active members will be driven by the lever set and urge an according slide motion of the passive members away from the active members, whereby the braking members will pinch the associated front bicycle wheel and force it to stop rotating.

### FIELD OF THE INVENTION

The present invention relates to bicycle braking systems, more particularly to a braking device for a bicycle improve from the invention disclosed by R.O.C. patent number 94219724.

### BACKGROUND OF THE INVENTION

In the prior art, the braking device for a bicycle is a transversely pulled braking device for a bicycle straddling a bicycle wheel having an arched hub on which a lever set is pivotally mounted, whereby a braking string transversely going through the lever set will be pulled to activate a synchronic motion of the lever set. The opposite inner sides of the lever set are pivotally attached with respective braking components, which will pinch the bicycle wheel when the braking string is pulled.

The braking components of the braking device for a bicycle of the prior art are symmetric with respect to the wheel, each having a braking piece.

On the outer sides of each of the braking components, there are a first pivotal ear and a second pivotal ear, which are up and down arranged. Each set of the first pivotal ears and the second pivotal ears is pivotally connected to a first link rod and a second link rod, whereby the first link rod, the second link rod and the braking components form a parallelogram. Thereby, as the braking string is pulled transverse to the wheel, the braking components will move accordingly horizontally toward the front fork frame and then pinch the wheel.

### SUMMARY OF THE INVENTION

The primary objective of the present invention is to provide a braking device for a bicycle activated by transverse pull wherein a pair of right and left braking components can pinch the lateral walls of a wheel simultaneously, whereby a precision braking force will be provided. To achieve the above objective, a braking device for a bicycle activated by transverse pull mainly comprises a lever set with a pair of left and right braking components, each having an active member and a passive member that are opposite wedged slab bodies slidably engaged. The active members are further attached with braking members. The active members will be driven by the lever set and urge an according slide motion of the passive members away from the active members, whereby the braking members will pinch the associated front bicycle wheel and force it to stop rotating.

### BRIEF DESCRIPTION OF THE DRAWINGS

FIG. 1 is an exploded perspective view of a braking device for a bicycle of the present invention.

FIG. 2 is a perspective view of the first preferred embodiment of the present invention.

FIG. 3 illustrates the first preferred embodiment not engaged with a wheel.

FIG. 4 illustrates the first preferred embodiment engaged with a wheel.

FIG. 5 is a perspective view of the second preferred embodiment of the present invention.

FIG. 6 illustrates the second preferred embodiment not engaged with a wheel.

FIG. 7 illustrates the second preferred embodiment engaged with a wheel.

FIG. 8 is a perspective view of the third preferred embodiment of the present invention.

FIG. 9 illustrates the third preferred embodiment not engaged with a wheel.

FIG. 10 illustrates the third preferred embodiment engaged with a wheel.

FIG. 11 is a perspective view of the fourth preferred embodiment of the present invention.

FIG. 12 illustrates the fourth preferred embodiment not engaged with a wheel.

FIG. 13 illustrates the fourth preferred embodiment engaged with a wheel.

FIG. 14 is a perspective view of the fifth preferred embodiment of the present invention.

FIG. 15 illustrates the fifth preferred embodiment not engaged with a wheel.

FIG. 16 illustrates the fifth preferred embodiment engaged with a wheel.

The various objects and advantages of the present invention will be more readily understood from the following detailed description when read in conjunction with the appended drawings.

### DETAILED DESCRIPTION OF THE PREFERRED EMBODIMENTS

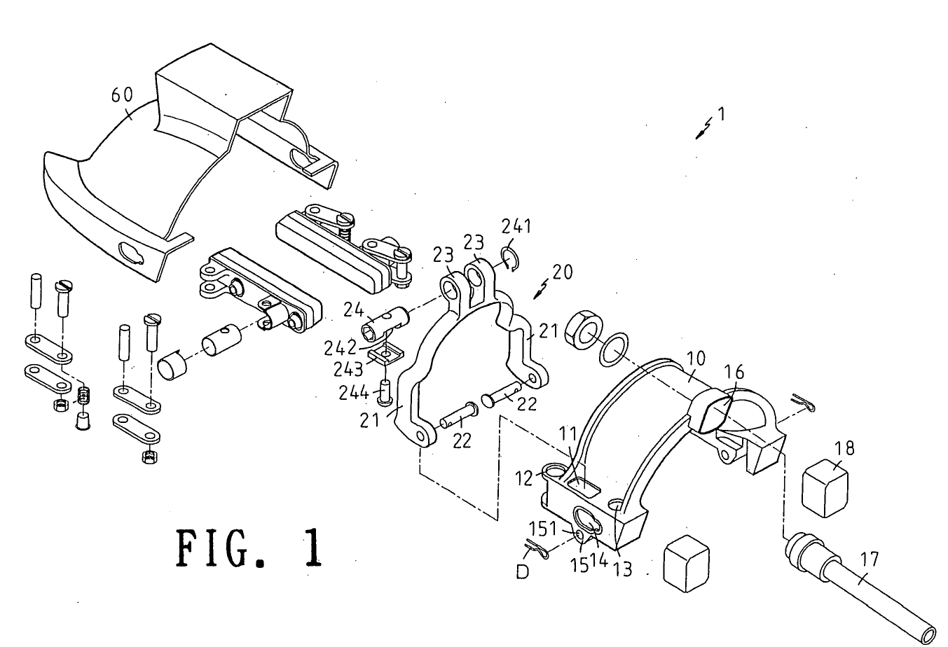

Referring to FIG. 1, a braking device for a bicycle according to the present invention is an improvement a braking device for a bicycle activated by transverse pull, which braking device 1 for a bicycle comprises a main body 10 being an arched-doom hub, a lever set 20 and a pair of left and right braking components 30.

One end of the main body 10 is further provided with two vertical lateral elongated through holes 11. Next to the front of the elongated through holes 11, there are two pairs of up and down arranged hollow ear portion 12.

Behind the elongated through holes 11, there are a pair of vertical round through hole 13. Two lateral sides of the main body 10 are provided with a pair of transverse pear-shaped slide holes 14. Each of the bottom edges of two lateral sides of the main body 10 is extended downwardly with a semi-circular flange 15 with a transverse axial hole 151. Further, a retaining hole 16 is formed on the top of the main body 10 at the rear end for the insertion of a longitudinal tube 17 that goes through the front fork frame of the bicycle, whereby the main body 10 can be mounted in front of the front fork frame. The arched internal space defined by two lateral walls of the main body 10 will form an up and down corresponding relation with the wheel pivoted between the fork members of the front fork frame. Further, to avoid collisions between the front fork frame and the main body 10, a pair of cushion pieces 18, made of a flexible plastic material such as plastic, rubber or sponge, are installed between them.

The lever set 20 has a pair of L-shaped lateral beams 21 that are connected to the main body 10 through the elongated through holes 11. The top portion of the lever set 20 is located above the top of the main body 10, whereas the L-shaped lateral beams 21 are respectively on two lateral sides of the main body 10. Thereby, two pivot axles 22 with a T-shaped cross section can be transversely inserted, from the interior of the main body 10 outwardly, into the axial holes 151 of the flanges 15. The outer part of each of the pivot axles 22 is then secured by a flexible connecting member D, whereby the lever set 20 is pivotally connected to the main body 10.

The top portion of the lever set 20 is extended with a pair of spaced, parallel ear portions 23 through which connecting unit for retaining a steel string (not shown) can be mounted and tightly stretched. The connecting unit comprises a connecting beam 24, a mount piece 243 and a connecting bolt 244. The cylindrical connecting beam 24 has a side groove for attaching a C-shaped retaining ring 241 for securing the connecting beam 24 on the ear portions 23. A bottom flat face 242 on the connecting beam 24 is for receiving the mount piece 243. The connecting bolt 244 will lock with the connecting bolt 244 through the mount piece 243. The steel string will go through the connecting bolt 244, the mount piece 243 and eventually into the longitudinal tube 17, whereby the lever set 20 will move with the steel string, and further the pair of left and right braking components 30 on the inner walls of the lever set 20 will be urged to pinch the bicycle wheel.

Since the braking device for a bicycle shown in FIG. 1 is an improvement from the braking device for a bicycle disclosed by a former patent, the first and the second link rods used in the barking system are not elaborated here.

The main feature of the present invention is improved braking components. There are five preferred embodiments of the braking components that will be described.

### The First Preferred Embodiment

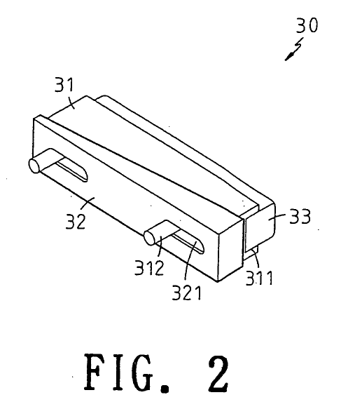

Referring to FIG. 2, each of the left and right braking components 30 has an active member 31, a passive member 32 and a braking member 33. The active member 31 is a wedge body with a U-shaped cross section in which the elongated braking member 33, made of a rubber material, is embedded. The side of the active member 31 opposite to the braking member 33 is a sloppy surface having a high front end and low rear end (closer to the rear end of the front fork frame). A cylindrical column 312 is extended outwardly from each end of the outer side of the active member 31. The passive member 32 has a sloppy outer surface having a low front end and high rear end. Two ends of the passive member 32 are respectively provided with elongated through holes 321 through which the cylindrical columns pierce. The sloppy outer surface and the sloppy inner surface of the active member 31 are engaged, and a slide motion related to each other is allowed.

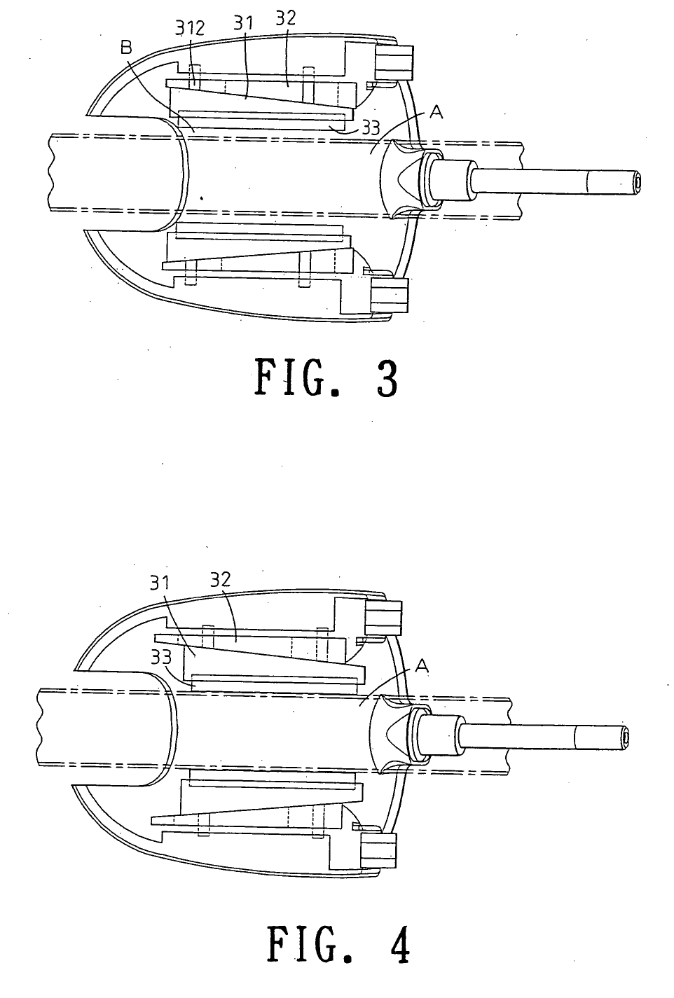

Referring to FIG. 3, the left and right braking components 30 mounted within the lower portion of the main body 10 are in a normal configuration wherein the braking members 33 are kept at a predetermined distance B with the lateral walls of a wheel A. As a user squeezes the braking device on a hand grip (not shown), the steel string will pull the lever set 20 in the transverse direction. The lever set 20 will drive the left and right braking components 30 accordingly so that the cylindrical columns 312 of the active members 31 will slide along the elongated through holes 321. As a consequence, each of the engaged pair of the active member 31 and the passive member 32 will slide away from each other, forcing the braking members 33 of the active members 31 to pinch the front wheel and achieving a braking effect.

### The Second Preferred Embodiment

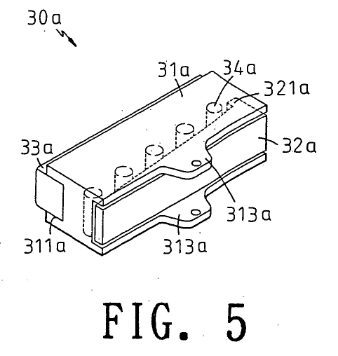

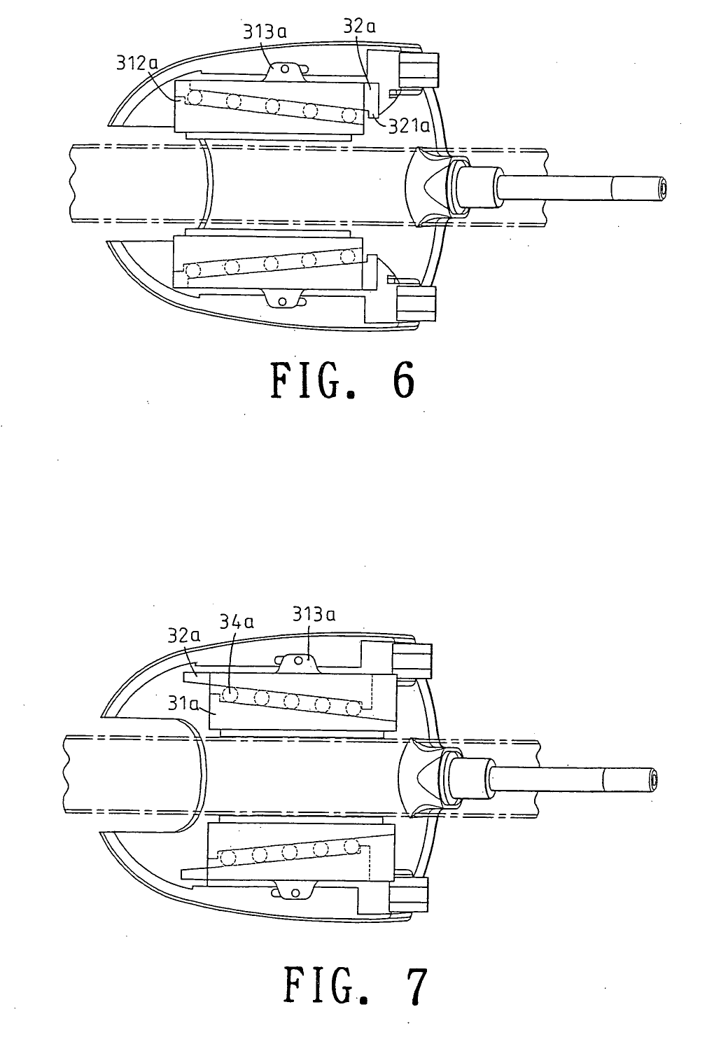

Referring to FIGS. 5 to 7, each of the left and right braking components 30a has an active member 31a, a passive member 32a and a braking member 33a. The active member 31a is a wedge body with a U-shaped inner groove 311a in which the elongated braking member 33a, made of a rubber material, is embedded. The outer side of the active member 31a opposite to the braking member 33a is a sloppy surface having a high front end and low rear end (closer to the rear end of the front fork frame). The front end of the sloppy surface is provided with a block portion 312a. The outer side of each of the active members 31a is provided with a pair of up and down arranged pivotal ear portions 313a. The passive members 32a are slidably attached onto the sloppy surfaces of the active members 31a. Each of the passive members 32a has a sloppy outer surface having a low front end and high rear end and another block portion 321a. Between the block portions 321a and 312a, there are several rolling poles 34a, whereby a relative slide motion of the passive members 32a will be achieved when the active members 31a are urged by the lever set 20, and whereby the braking members 33a will pinched the front wheel as the active members 31a and the passive members 32a are moving away from each other.

### The Third Preferred Embodiment

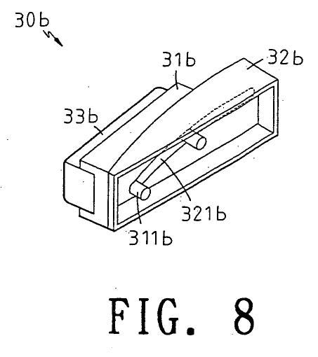

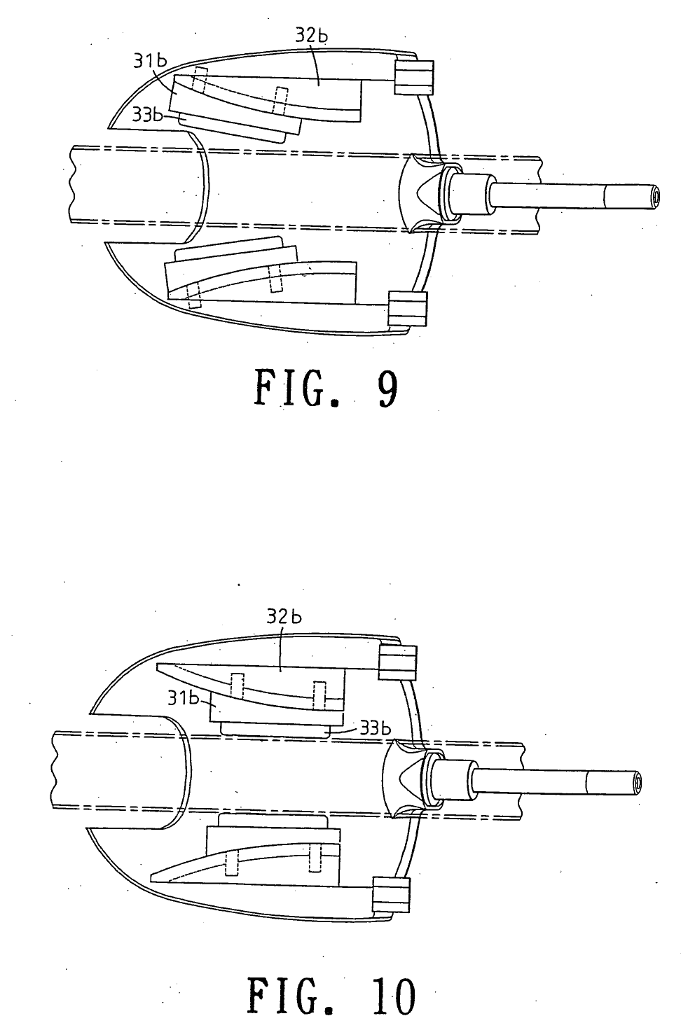

Referring to FIGS. 8 to 10, each of the left and right braking components 30b has an active member 31b, a passive member 32b and a braking member 33b. The active member 31b is a wedge body with a U-shaped inner groove 311b in which the elongated braking member 33b, made of a rubber material, is embedded. The side of the active member 31b opposite to the braking member 33b is a curved sloppy surface having a high front end and low rear end (closer to the rear end of the front fork frame). A cylindrical column 312b is extended outwardly from each end of the outer side of the active member 31b. The passive member 32b has a curved sloppy outer surface having a low front end and high rear end. Two ends of the passive member 32b are respectively provided with elongated curved holes 321 through which the cylindrical columns 312b pierce. The sloppy outer surface of the passive member 32b and the sloppy inner surface of the active member 31b are engaged, and a slide motion related to each other is allowed. A relative slide motion of the passive members 32b will be achieved when the active members 31b are urged by the lever set 20, and whereby the braking members 33b will pinched the front wheel as the active members 31b and the passive members 32b are moving away from each other.

### The Fourth Preferred Embodiment

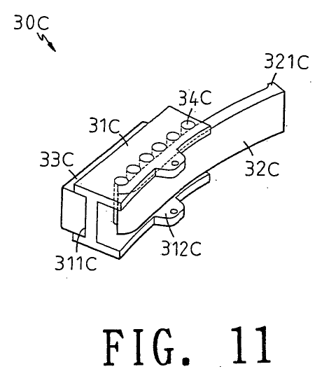

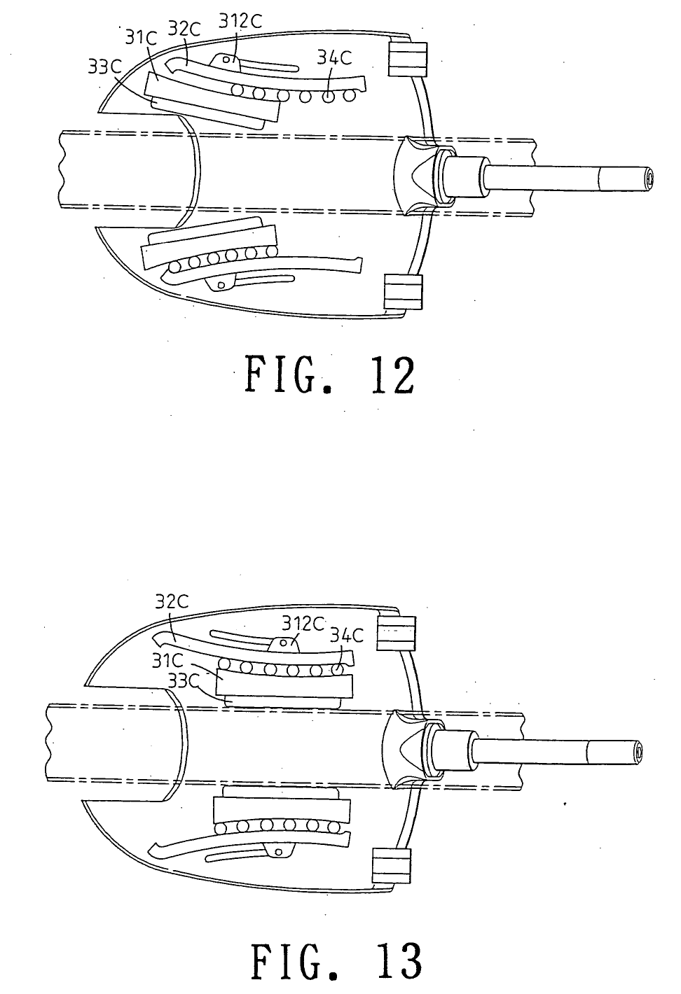

Referring to FIGS. 11 to 13, each of the left and right braking components 30c has an active member 31c, a passive member 32c and a braking member 33c. The active member 31c is an arced elongated body with an H-shaped cross section, with the inner U-shaped groove where the elongated braking member 33c, made of a rubber material, is embedded. The outer U-shaped groove of the active member 31c is designed to be arced surface. The outer side of each of the active members 31c is provided with a pair of up and down arranged pivotal ear portions 312c that are linked to the lever set 20. The passive members 32c, each being an arced slab provided with two end block portions 321c, are slidably attached onto the outer surfaces of the active members 31c. Between the block portions 321c, there are several rolling poles 34c, whereby a relative slide motion of the passive members 32c will be achieved when the active members 31c are urged by the lever set 20, and whereby the braking members 33c will pinched the front wheel as the active members 31c and the passive members 32c are moving away from each other.

### The Fifth Preferred Embodiment

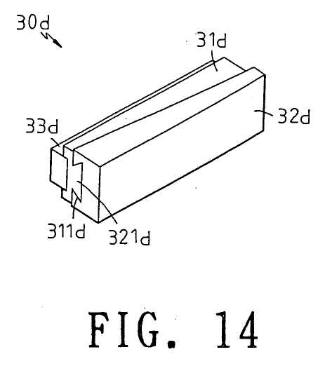

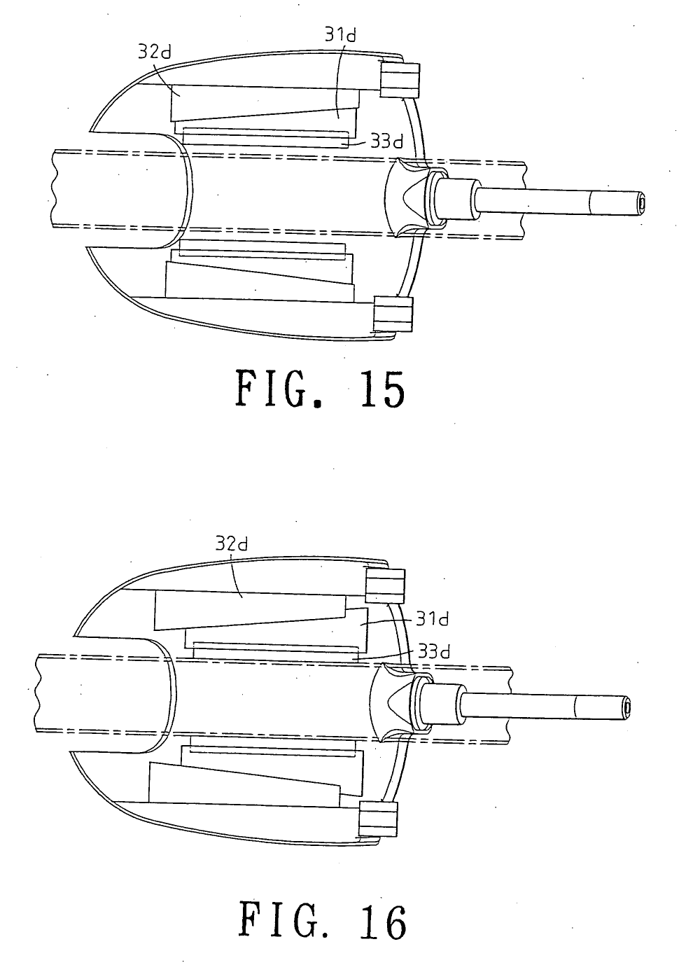

Referring to FIGS. 14 to 16, each of the left and right braking components 30d has an active member 31d, a passive member 32d and a braking member 33d. The active member 31d is a wedged slab body having a high front end and low rear end (closer to the rear end of the front fork frame). The inner side of the active member 31d is provided with a first dovetail joint member 311d with narrower opening, and the outer side of the passive member 32d is provided with a second dovetail joint member 321d, whereby the dovetail joint members (311d, 321d) can secure a relative slide motion between the active member 31d and the passive member 32d. The U-shaped outer side of the active member 31d is further embedded with the braking member 33d. A relative slide motion of the passive members 32d will be achieved when the active members 31d are urged by the lever set 20, and whereby the braking members 33d will pinched the front wheel as the active members 31d and the passive members 32d are moving away from each other.

Further, the main body 10 can be shielded with a cover body 60 for protecting and beautifying the brake system.

Five preferred embodiments of the present invention are thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A braking device for a bicycle, comprising:
a main body mounted in front of a front fork frame that pivotally retain a bicycle wheel, said main body being further pivotally mounted with a pair of lever components, said lever components being connected to a steel braking string to form a transmission relation, whereby said braking string will be pulled transversely so as to drive said lever components to pinch against said bicycle wheel; and
a pair of left and right braking components each having an active member and a passive member that are opposite wedged slab bodies slidably engaged, an inner wall of said passive member being provided with a braking member.

2. The braking device for a bicycle of claim 1 wherein each of said active members is a U-shaped wedged slab body with an inner flat surface on which a corresponding one of said braking members is attached and an outer sloppy surface having a high front end, a lower rear end and two cylindrical columns extended outwardly and passing through two corresponding elongated through holes on a corresponding one of said passive member.

3. The braking device for a bicycle of claim 1 wherein each of said active members is a wedged slab body with a U-shaped inner flat surface on which a corresponding one of said braking members is attached and a U-shaped outer sloppy surface having a high front end and a lower rear end; a front end of said outer sloppy surface being provided with a block portion; a middle section of said outer sloppy surface being provided with a pair of up and down arranged ear portions for engaging said lever components; an inner wall of each of said passive members having sloppy inner surface with a high rear end and a low front end; a set of rolling columns being provided between each pair of said active members and said passive members.

4. The braking device for a bicycle of claim 1 wherein each of said active members has a curved sloppy outer surface having a high front end and low rear end; a cylindrical column is extended outwardly from each end of the outer side of said active member; said passive member having a curved sloppy outer surface with a low front end and high rear end; two ends of said passive member are respectively provided with elongated curved holes through which said cylindrical columns pierce; thereby, said sloppy outer surface of said passive member and said sloppy inner surface of said active member are slidably engaged.

5. The braking device for a bicycle of claim 1 wherein each of said active members is an arced elongated body with an H-shaped cross section, with an inner U-shaped groove where the elongated braking member is embedded and an outer U-shaped recessed surface of said active member being an arced surface; an outer side of each of said active members being provided with a pair of up and down arranged pivotal ear portions that are linked to said lever components; each of said passive members being an arced slab and being slidably attached onto said outer surfaces of said active members; there are several rolling poles between each pair of said active members and said passive members, whereby a relative slide motion therebetween will be achieved.

6. The braking device for a bicycle of claim 1 wherein each of said active members is a wedged slab body having an inner wall with a high front end, low rear end and a first dovetail joint member; an outer wall of each of said passive members is provided with a second dovetail joint member, whereby the dovetail joint members can secure a relative slide motion between each pair of said active members and said passive members.

7. The braking device for a bicycle of claim 1 wherein said main body is further provided with two vertical lateral elongated through holes for the insertion of two lever components; thereby, two pivot axles with a T-shaped cross section being capable of being transversely inserted, from the interior of said main body outwardly, into a pair of axial holes of two lateral flanges thereon; said main body being connected with a top longitudinal tube linked to said front fork frame, whereby said braking string emerged form said front fork frame will connect said lever components to form a coupled relation.

8. The braking device for a bicycle of claim 1 wherein said main body has a upper square hole for retaining a longitudinal tube.

9. The braking device for a bicycle of claim 1 wherein a horizontal section extended from two lateral sides of lever components is provided by a through hole for receiving a pivotal axle; two spaced, parallel ear portions being formed on top of said lever components for the connection of said braking string.

10. The braking device for a bicycle of claim 1 wherein said main body is further shielded by a cover body with an arched doom.

11. The braking device for a bicycle of claim 1 wherein there are a pair of cushion pieces mounted between a rear end of said main body and said front fork frame.

12. The braking device for a bicycle of claim 7 wherein outer ends of said pivot axles going through said lever components and said main body are respectively provided with flexible connecting members for pivotally attached said lever components onto said main body.
